(19) United States
(12) Patent Application Publication
(10) Pub. No.: US 2025/0124538 A1
(43) Pub. Date: Apr. 17, 2025

(54) ELECTRONIC DEVICE FOR PROJECTING IMAGE ONTO SCREEN INCLUDING PLURALITY OF SURFACES, AND CONTROL METHOD

(71) Applicant: SAMSUNG ELECTRONICS CO., LTD., Suwon-si (KR)

(72) Inventors: Youngchol LEE, Suwon-si (KR); Byungseok SOH, Suwon-si (KR); Bonseuk GOO, Suwon-si (KR); Youngtae KIM, Suwon-si (KR); Kisung LEE, Suwon-si (KR); Weonhee LEE, Suwon-si (KR); Yongseok JANG, Suwon-si (KR)

(73) Assignee: SAMSUNG ELECTRONICS CO., LTD., Suwon-si (KR)

(21) Appl. No.: 18/999,609

(22) Filed: Dec. 23, 2024

Related U.S. Application Data
(63) Continuation of application No. PCT/KR2023/007189, filed on May 25, 2023.

(30) Foreign Application Priority Data
Jun. 23, 2022 (KR) 10-2022-0077111
Aug. 29, 2022 (KR) 10-2022-0108731

(51) Int. Cl. G06T 3/08; G06T 7/11; G06T 7/50

(52) U.S. Cl. CPC G06T 3/08; G06T 7/11; G06T 7/50

(57) ABSTRACT

An electronic device includes: a projector; a camera; one or more processors; and memory storing instructions that, when executed by the one or more processors, cause the electronic device to: control the projector to display a projected image on a screen, wherein the screen includes surfaces; control the camera to obtain a captured image including the surfaces and the projected image; identify, based on the captured image, shapes of the surfaces and areas of the projected image projected onto the surfaces; and correct the projected image, based on the shapes of the surfaces and the areas of the projected image, by transforming the projected image into one from among a three-dimensional image and a flat image.

### CROSS-REFERENCE TO RELATED APPLICATIONS

This application is a by-pass continuation application of International Application No. PCT/KR2023/007189, filed on May 25, 2023, which is based on and claims priority to Korean Patent Application No. 10-2022-0077111, filed in the Korean Intellectual Property Office on Jun. 23, 2022, and Korean Patent Application No. 10-2022-0108731, filed in the Korean Intellectual Property Office on Aug. 29, 2022, the disclosures of which are incorporated by reference herein in their entireties.

### 1. FIELD

The present disclosure relates to an electronic device for projecting an image onto a screen and a control method thereof.

### 2. DESCRIPTION OF RELATED ART

An electronic device may be implemented in any of various forms. For example, the electronic device may be implemented in the form of a display device, a lighting device, an audio device, or the like. The electronic device may be implemented in the form of a projector. The projector may be an electronic device for projecting light onto a screen (or a projection surface) to provide an image on the screen. In addition, the electronic device implemented in the form of a projector may also be implemented to include functions of the display device, the lighting device, or the audio device.

### SUMMARY

According to an aspect of the disclosure, an electronic device includes: a projector; a camera; one or more processors; and memory storing instructions that, when executed by the one or more processors, cause the electronic device to: control the projector to display a projected image on a screen, wherein the screen includes a plurality of surfaces; control the camera to obtain a captured image including the plurality of surfaces and the projected image; identify, based on the captured image, shapes of the plurality of surfaces and a plurality of areas of the projected image projected onto the plurality of surfaces; and correct the projected image, based on the shapes of the plurality of surfaces and the plurality of areas of the projected image, by transforming the projected image into one from among a three-dimensional image and a flat image.

The one or more processors may be configured to execute the instructions to cause the electronic device to correct the projected image by transforming the projected image into the three-dimensional image based on: the plurality of surfaces including a first surface and a second surface, and a smallest area, from among a first area projected onto the first surface and a second area projected onto the second surface, having a horizontal top edge or a horizontal bottom edge.

The one or more processors may be configured to execute the instructions to cause the electronic device to: segment the projected image into the first area and the second area; correct the first area by transforming the first area into a right-angled rectangular shape; correct the second area by transforming the second area into a parallelogram; obtain a merged image by merging the first area and the second area; and project the merged image.

The one or more processors may be configured to execute the instructions to cause the electronic device to correct the projected image by transforming the projected image into the three-dimensional image based on: the plurality of surfaces including three surfaces and the plurality of areas of the projected image each having four or more edges.

The one or more processors may be configured to execute the instructions to cause the electronic device to: segment the projected image into three areas; correct the three areas, based on three corresponding surface shapes, by transforming the three areas into parallelograms; obtain a merged image by merging the three areas; and project the merged image.

The one or more processors may be configured to execute the instructions to cause the electronic device to correct the projected image by transforming the projected image into the flat image based on: the plurality of surfaces including three surfaces and at least one of the plurality of areas of the projected image including three edges.

The one or more processors may be configured to execute the instructions to cause the electronic device to: segment the projected image into three areas; correct two side areas, from among the three areas, to have parallel bottom edges; obtain a merged image by merging the three areas; and project the merged image.

The one or more processors may be configured to execute the instructions to cause the electronic device to: determine whether movement of the electronic device has occurred; and identify, based on determining no movement has occurred: the shapes of the plurality of surfaces, and the plurality of areas of the projected image.

The one or more processors may be configured to execute the instructions to cause the electronic device to determine whether movement of the electronic device has occurred by detecting movement of the projected image in the captured image.

The electronic device may further include a sensor, and the one or more processors may be configured to execute the instructions to cause the electronic device to: control the sensor to obtain detected information about movement of the electronic device; and determine whether movement of the electronic device has occurred based on the detected information.

According to an aspect of the disclosure, a control method of an electronic device, includes: displaying a projected image on a screen including a plurality of surfaces; obtaining a captured image including the plurality of surfaces and the projected image; identifying, based on the captured image, shapes of the plurality of surfaces and a plurality of areas of the projected image; and correcting the projected image, based on the shapes of the plurality of surfaces and the plurality of areas of the projected image, by transforming the projected image into one from among a three-dimensional image and a flat image.

The correcting the projected image may include transforming the projected image into the three-dimensional image based on: the plurality of surfaces including a first surface and a second surface, and a smallest area, from among a first area projected onto the first surface and a second area projected onto the second surface, having a horizontal top edge or a horizontal bottom edge.

The correcting the projected image may include: segmenting the projected image into the first area and the second area; correcting the first area by transforming the first area into a right-angled rectangular shape; correcting the second area by transforming the second area into a parallelogram; obtaining a merged image by merging the first area and the second area; and projecting the merged image.

The correcting the projected image may include transforming the projected image into the three-dimensional image based on: the plurality of surfaces including three surfaces and the plurality of areas of the projected image each having four or more edges.

The correcting the projected image may include: segmenting the projected image into three areas; correcting the three areas, based on three corresponding surface shapes, by transforming the three areas into parallelograms; obtaining a merged image by merging the three areas; and projecting the merged image.

The correcting the projected image may include transforming the projected image into the flat image based on: the plurality of surfaces including three surfaces and at least one of the plurality of areas of the projected image including three edges.

The correcting the projected image may include: segmenting the projected image into three areas; correcting two side areas, from among the three areas, to have parallel bottom edges; obtaining a merged image by merging the three areas; and projecting the merged image.

The identifying the shapes of the plurality of surfaces and the plurality of areas of the projected image may include: determining whether movement of the electronic device has occurred; and identifying, based on determining no movement has occurred: the shapes of the plurality of surfaces, and the plurality of areas of the projected image.

The determining whether the movement has occurred may be based on detecting movement of the projected image in the captured image.

According to an aspect of the disclosure, a non-transitory computer-readable recording medium having instructions recorded thereon, that, when executed by one or more processors, cause the one or more processors to: control a projector to display a projected image on a screen, wherein the screen includes a plurality of surfaces; control a camera to obtain a captured image including the plurality of surfaces and the projected image; identify, based on the captured image, shapes of the plurality of surfaces and a plurality of areas of the projected image projected onto the plurality of surfaces; and correct the projected image, based on the shapes of the plurality of surfaces and the plurality of areas of the projected image, by transforming the projected image into one from among a three-dimensional image and a flat image.

### BRIEF DESCRIPTION OF THE DRAWINGS

FIG. 1 is a perspective view showing an appearance of an electronic device according to various embodiments.

FIG. 2 is a block diagram showing a detailed configuration of the electronic device according to an embodiment.

FIGS. 3A to 8B are perspective views showing an appearance of the electronic device according to the various embodiments.

FIG. 9 is a block diagram of the electronic device according to an embodiment of the present disclosure.

FIG. 10 is a view for explaining the electronic device for projecting an image onto a screen including a plurality of surfaces according to an embodiment of the present disclosure.

FIGS. 11A and 11B are views for explaining a process of providing a three-dimensional image if the image is projected onto a screen including three surfaces according to an embodiment of the present disclosure.

FIGS. 12A and 12B are views for explaining a process of providing a flat image if the image is projected onto the screen including three surfaces according to an embodiment of the present disclosure.

FIGS. 13A and 13B are views for explaining a process of providing the three-dimensional image if the image is projected onto a screen including two surfaces according to an embodiment of the present disclosure.

FIG. 14 is a flowchart for explaining a control method of an electronic device according to an embodiment of the present disclosure.

FIG. 15 is a flowchart for explaining a method of selectively implementing a flat image or a three-dimensional image if an image is projected onto a screen including a plurality of surfaces according to an embodiment of the present disclosure.

### DETAILED DESCRIPTION

Hereinafter, various embodiments are described in more detail with reference to the accompanying drawings. The embodiments described may be modified in various ways. An embodiment may be shown in the drawings and described in detail in a detailed description. However, the embodiment disclosed in the accompanying drawings is provided only to assist in easy understanding of the various embodiments. Therefore, it should be understood that the spirit of the present disclosure is not limited by the embodiment shown in the accompanying drawings, and includes all the equivalents and substitutions included in the spirit and scope of the present disclosure.

Terms including ordinal numbers such as “first” and “second” may be used to describe various components. However, these components are not limited by these terms. The terms are used only to distinguish one component and another component from each other.

It should be understood that terms “include” and “have” may indicate the presence of features, numerals, steps, operations, components, parts, or combinations thereof, and do not preclude the presence or addition of one or more other features, numerals, steps, operations, components, parts, or combinations thereof. It is to be understood that if one component is referred to as being “connected to” or “coupled to” another component, one component may be directly connected to or directly coupled to another component, or may be connected to or coupled to another component while having a third component interposed therebetween. On the other hand, it is to be understood that if one component is referred to as being “directly connected to” or “directly coupled to” another component, one component may be connected or coupled to another component without a third component interposed therebetween.

Meanwhile, the term “module” or “˜er/˜or” for components may perform at least one function or operation. In addition, the “module” or “˜er/˜or” may perform the function or operation by hardware, software, or a combination of hardware and software. In addition, a plurality of “modules” or a plurality of “˜ers/˜ors” except for a module” or “˜er/˜or” performed by hardware or performed by at least one processor may be integrated into at least one module. A term of a single number may include its plural number unless explicitly indicated otherwise in the context.

In describing the present disclosure, a sequence of each operation should be understood as non-restrictive unless a preceding operation in the sequence of each operation needs to logically and temporally precede a subsequent operation. The essence of the present disclosure is not affected even though a process described as the subsequent operation is performed before a process described as the preceding operation, and the scope of the present disclosure should also be defined regardless of the sequence of the operations. “A or B” may be defined to indicate not only selectively indicating either one of A and B, but also including both A and B. In addition, the term “including” may have a meaning encompassing further including other components in addition to components listed as being included.

Components for the present disclosure are described herein. In addition, it should not be interpreted as an exclusive meaning that the present disclosure includes only the mentioned components, but should be interpreted as a non-exclusive meaning that the present disclosure may include other components as well.

Meanwhile, the respective embodiments may be implemented or operated independently, and may be implemented or operated in combination.

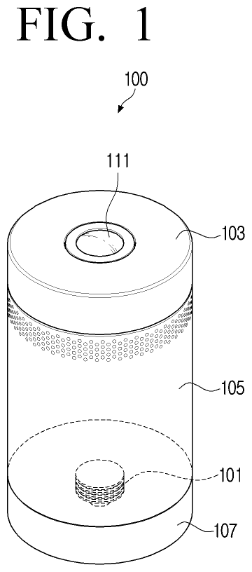

FIG. 1 is a perspective view showing an appearance of an electronic device according to various embodiments.

Referring to FIG. 1, the electronic device 100 may include a connector 101, a head 103, a body 105, a cover 107, or a projection lens 111.

The electronic device 100 may be any of various types of devices. In particular, the electronic device 100 may be a projector device that enlarges and projects an image on a wall or a screen, and the projector device may be a liquid crystal display (LCD) projector or a digital light processing (DLP) type projector that uses a digital micromirror device (DMD).

In addition, the electronic device 100 may be a home or industrial display device, a lighting device used in daily life, or an audio device including a sound module, or may be implemented as a portable communication device (e.g., smartphone), a computer device, a portable multimedia device, a wearable device, a home appliance, or the like. Meanwhile, the electronic device 100 according to the various embodiments of the present disclosure is not limited to the above-mentioned devices, and may be implemented as the electronic device 100 having two or more functions of the above-mentioned devices. For example, the electronic device 100 may be used as the display device, the lighting device, or the audio device by turning off its projector function and turning on its lighting function or speaker function on the basis of a manipulation of a processor, and may be used as an artificial intelligence (AI) speaker by including a microphone or a communication device.

The projection lens 111 may be disposed on one surface of the body 105, and project light passed through a lens array to the outside of the body 105. The projection lens 111 in the various embodiments may be an optical lens which is low-dispersion coated to reduce chromatic aberration. The projection lens 111 may be a convex lens or a condensing lens, and the projection lens 111 according to the various embodiments may adjust a focus by adjusting positions of a plurality of sub-lenses.

The head 103 may be coupled to one surface of the body 105 to thus support and protect the projection lens 111. The head 103 may be coupled to the body 105 to be swiveled within a predetermined angle range based on one surface of the body 105.

The head 103 may be automatically or manually swiveled by a user or the processor to thus freely adjust a projection angle of the projection lens 111. The head 103 may be coupled to the body 105 and include a neck extending from the body 105, and the head 103 may be tilted or inclined to thus adjust the projection angle of the projection lens 111.

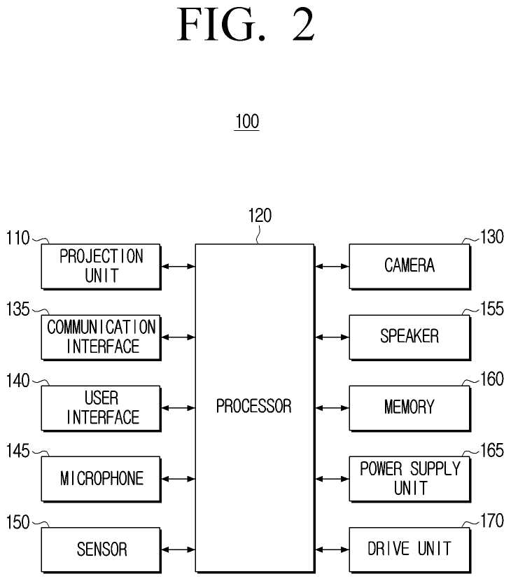

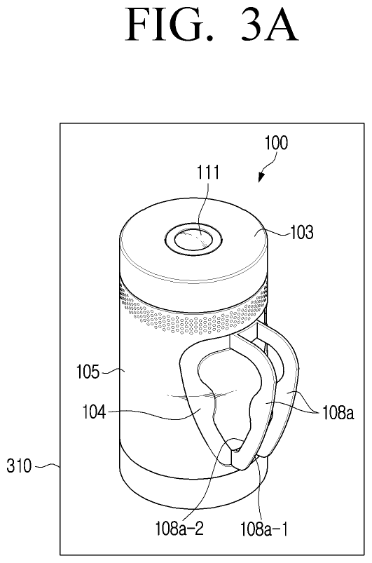

The body 105 is a housing constituting the appearance, and may support or protect components of the electronic device 100 (e.g., components shown in FIG. 2) disposed in the body 105. The body 105 may have a shape close to a cylinder as shown in FIG. 1. However, the shape of the body 105 is not limited thereto, and according to the various embodiments of the present disclosure, the body 105 may be implemented in various geometrical shapes such as a column having polygonal cross sections, a cone, or a sphere.

The body 105 may have a size enabling the body to be gripped or moved by the user with his/her one hand, or may be implemented in a micro size enabling the body to be easily carried or a size enabling the body to be held on a table or to be coupled to the lighting device.

A material of the body 105 may be matt metal or synthetic resin for a user fingerprint or dust not to smear the body. An appearance of the body 105 may be made of a slick glossy material.

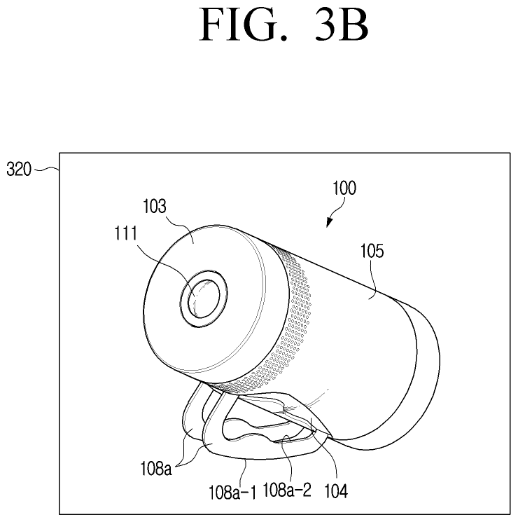

The body 105 may have a friction area disposed on a partial area of the appearance of the body 105 to be gripped and moved by the user. The body 105 may have a folded gripping part or a support 108a (see FIG. 3) disposed in at least the partial area and capable of being gripped by the user.

The electronic device 100 may project light or the image to a desired location by adjusting a direction of the head 103 while the position and angle of the body 105 are fixed and by adjusting the projection angle of the projection lens 111. In addition, the head 103 may include a handle that the user may grip after rotating the head in a desired direction.

A plurality of openings may be disposed in an outer circumferential surface of the body 105. Audio output from an audio output unit may be output outside the body 105 of the electronic device 100 through the plurality of openings. The audio output unit may include a speaker, and the speaker may be used for general uses such as reproduction of multimedia or reproduction of recording, and output of a voice.

According to the various embodiments of the present disclosure, the body 105 may include a radiation fan disposed therein, and if the radiation fan is driven, air or heat in the body 105 may be discharged through the plurality of openings. Accordingly, the electronic device 100 may discharge heat occurring due to the driving of the electronic device 100 to the outside, and prevent overheating of the electronic device 100.

The connector 101 may connect the electronic device 100 with an external apparatus to transmit or receive an electronic signal, or receive power from the external apparatus. The connector 101 according to the various embodiments of the present disclosure may be physically connected with the external apparatus. Here, the connector 101 may include an input/output interface to connect its communication with the external apparatus in a wired or wireless manner or receive the power from the external apparatus. For example, the connector 101 may include a high-definition multimedia interface (HDMI) connection terminal, a universal serial bus (USB) connection terminal, a secure digital (SD) card accommodating groove, an audio connection terminal, or a power outlet. The connector 101 may include Bluetooth, wireless-fidelity (Wi-Fi), or a wireless charge connection module, connected with the external apparatus in the wireless manner.

In addition, the connector 101 may have a socket structure connected to an external lighting device, and may be connected to a socket accommodating groove of the external lighting device to receive power. The size and specification of the connector 101 having the socket structure may be implemented in various ways in consideration of an accommodating structure of the external apparatus that may be coupled thereto. For example, a diameter of a joining portion of the connector 101 may be 26 mm according to an international standard E26, and in this case, the electronic device 100 may be coupled to the external lighting device such as a stand in place of a light bulb that is generally used. Meanwhile, in case of being connected to a socket located on an existing ceiling, the electronic device 100 having a structure that projects the image from top to bottom may not be rotated by being coupled to the socket, and in this case, the screen may not be able to be rotated either. Accordingly, the electronic device 100 may project or rotate the screen to the desired position while being socket-coupled to the stand on the ceiling by allowing the head 103 to be swiveled on one surface of the body 105 to have an adjusted projection angle for the electronic device 100 to be rotated even in case of being socket-coupled and receiving power.

The connector 101 may include a coupling sensor, and the coupling sensor may sense whether the connector 101 and the external apparatus are coupled to each other or their coupling state or coupling target, and transmit the same to the processor, and the processor may control an operation of the electronic device 100 on the basis of a received detection value.

The cover 107 may be coupled to or separated from the body 105, and protect the connector 101 for the connector 101 not to be always exposed to the outside. The cover 107 may have a shape continued from the shape of the body 105 as shown in FIG. 1, or may be implemented to correspond to a shape of the connector 101. The cover 107 may support the electronic device 100, and the electronic device 100 may be used by being coupled to or held on an external holder while being coupled to the cover 107.

In the electronic device 100 according to the various embodiments, a battery may be disposed inside the cover 107. The battery may include, for example, a non-rechargeable primary battery, a rechargeable secondary battery, or a fuel cell.

The electronic device 100 may include a camera module, and the camera module may capture still and moving images. According to the various embodiments, the camera module may include at least one lens, an image sensor, an image signal processor, or a flash.

The electronic device 100 may include a protective case to protect the electronic device 100 and facilitate its transportation, or include the stand that supports or fixes the body 105, a bracket that may be coupled to a wall surface or a partition.

In addition, the electronic device 100 may be connected with the various external apparatuses by using its socket structure to thus provide various functions. The electronic device 100 according to the various embodiments may be connected with an external camera device by using the socket structure. The electronic device 100 may provide an image stored in the camera device connected thereto or an image currently being captured by using a projection unit 110 (or projector). In another embodiment, the electronic device 100 may be connected to a battery module and supplied with power using the socket structure. Meanwhile, the electronic device 100 may be connected to the external apparatus using the socket structure, which is only one of the various embodiments, and may be connected to the external apparatus using another interface (e.g., USB).

FIG. 2 is a block diagram showing a configuration of the electronic device 100 according to the various embodiments.

Referring to FIG. 2, the electronic device 100 may include the projection unit 110, a processor 120, a camera 130, a communication interface 135, a user interface 140, a microphone 145, a sensor 150, a speaker 155, a memory 160, a power supply unit 165, and a drive unit 170. Meanwhile, the configuration shown in FIG. 2 is only an embodiment, and to which a new configuration may be added.

The projection unit 110 may be a component for projecting the image to the outside. The projection unit 110 according to an embodiment of the present disclosure may be implemented in any of various projection types (e.g., cathode-ray tube (CRT) type, liquid crystal display (LCD) type, digital light processing (DLP) type, or laser type). As one example, the CRT type may have the same principle as the principle of a CRT monitor. The CRT type may display the image on the screen by enlarging the image using a lens in front of a cathode-ray tube (CRT). The CRT type may be classified into a one-tube type and a three-tube type on the basis of the number of cathode-ray tubes, and in the three-tube type, the cathode-ray tubes of red, green, and blue may be separated from one another.

As another example, the LCD type may display the image by allowing light emitted from a light source to pass through a liquid crystal. The LCD type may be classified into a single-panel type and a three-panel type. In case of the three-plate type, light emitted from the light source may be separated into red, green, and blue in a dichroic mirror (which is a mirror that reflects only light of a color and allows the rest to pass therethrough), may then pass through the liquid crystal, and may then be collected into one place again.

As yet another example, the DLP type may display the image by using a digital micromirror device (DMD) chip. The DLP type projection unit may include a light source, a color wheel, the DMD chip, a projection lens, etc. Light emitted from the light source may be colored as passing through a rotating color wheel. Light passed through the color wheel may be input into the DMD chip. The DMD chip may include numerous micromirrors and reflect light input into the DMD chip. The projection lens may expand light reflected from the DMD chip to an image size.

As still another example, the laser type may include a diode pumped solid state (DPSS) laser and a galvanometer. The laser type that outputs various colors may use a laser in which three DPSS lasers are respectively installed for red, green, and blue (RGB) colors, and their optical axes overlap each other by using a special mirror. The galvanometer may include a mirror and a high-power motor, and move the mirror at a high speed. For example, the galvanometer may rotate the mirror at up to 40 KHz/sec. The galvanometer may be mounted in a scanning direction, and in general, a projector performs planar scanning, and the galvanometer may thus also be disposed by being divided into x and y axes.

Meanwhile, the projection unit 110 may include light sources of various types. For example, the projection unit 110 may include at least one light source of a lamp, a light emitting diode (LED), or the laser.

The projection unit 110 may output the image in a screen ratio of 4:3, a screen ratio of 5:4, and a wide screen ratio of 16:9, on the basis of a purpose of the electronic device 100, a user setting, or the like, and may output the image having various resolutions such as wide video graphics array WVGA (854*480 pixels), super video graphics array SVGA (800*600 pixels), extended graphics array XGA (1024*768 pixels), wide extended graphics array WXGA (1280*720 pixels), WXGA (1280*800 pixels), super extended graphics array SXGA (1280*1024 pixels), ultra extended graphics array UXGA (1600*1200 pixels), and full high-definition HD (1920*1080 pixels), on the basis of the screen ratio.

Meanwhile, the projection unit 110 may perform various functions for adjusting the output image under control of the processor 120. For example, the projection unit 110 may perform a zoom function, a keystone function, a quick corner (or four corner) keystone function, a lens shift function, or the like.

In detail, the projection unit 110 may enlarge or reduce the image based its distance (for example, projection distance) to the screen. The projection unit 110 may perform the zoom function on the basis of its distance to the screen. Here, the zoom function may include a hardware method of adjusting a screen size by moving a lens, and a software method of adjusting the screen size by cropping the image, or the like. Meanwhile, in case that the zoom function is performed, a focus of the image may be adjusted. For example, a method of adjusting the focus may include a manual focusing method, an electric focusing method, etc. The manual focusing method may indicate a method of manually adjusting the focus, and the electric focusing method may indicate a method in which the projector automatically adjusts the focus by using a motor built therein in case of performing the zoom function. In case of performing the zoom function, the projection unit 110 may provide a digital zoom function through software, and may provide an optical zoom function in which the zoom function is performed by moving the lens using the drive unit 170.

In addition, the projection unit 110 may perform the keystone correction function. If a height does not match a front projection, the screen may be distorted up or down. The keystone correction function may be a function of correcting a distorted screen. For example, in case that the distortion occurs on the screen in a horizontal direction, the distortion may be corrected using a horizontal keystone, and in case that the distortion occurs on the screen in a vertical direction, the distortion may be corrected using a vertical keystone. The quick corner (or four corner) keystone correction function may be a function of correcting the screen in case that a balance between corner areas of the screen is not appropriate while a central area of the screen is normal. The lens shift function may be a function of moving the screen as it is in case that the screen is outside the screen.

Meanwhile, the projection unit 110 may provide the zoom/keystone/focusing functions by automatically analyzing a surrounding environment and a projection environment without a user input. In detail, the projection unit 110 may automatically provide the zoom/keystone/focusing functions, on the basis of the distance between the electronic device 100 and the screen, information about a space where the electronic device 100 is currently positioned, information about an amount of ambient light, or the like, detected by the sensor (e.g., depth camera, distance sensor, infrared sensor, or light sensor).

In addition, the projection unit 110 may provide a lighting function by using the light source. In particular, the projection unit 110 may provide the lighting function by outputting the light source using the LED. In an embodiment, the projection unit 110 may include one LED, and in another embodiment, the electronic device 100 may include the plurality of LEDs. Meanwhile, the projection unit 110 may output the light source by using a surface-emitting LED in an implementation example. Here, the surface-emitting LED may be an LED in which an optical sheet is disposed on an upper side of the LED for the light source to be evenly dispersed and output. In detail, in case of being output through the LED, the light source may be evenly dispersed through the optical sheet, and the light source dispersed through the optical sheet may be incident on a display panel.

Meanwhile, the projection unit 110 may provide the user with a dimming function for adjusting intensity of the light source. In detail, the projection unit 110 may control the LED to output the intensity of the light source that corresponds to a received user input in case of receiving the user input for adjusting the intensity of the light source from the user through the user interface 140 (e.g., touch display button or dial).

In addition, the projection unit 110 may provide the dimming function, on the basis of content analyzed by the processor 120 without the user input. In detail, the projection unit 110 may control the LED to output the intensity of the light source, on the basis of information (e.g., content type or content brightness) about the currently-provided content.

Meanwhile, the projection unit 110 may control a color temperature under the control of the processor 120. Here, the processor 120 may control the color temperature on the basis of the content. In detail, if it is identified that the content is to be output, the processor 120 may obtain color information for each frame of the content whose output is determined. The processor 120 may then control the color temperature on the basis of the obtained color information for each frame. Here, the processor 120 may obtain at least one main color of the frame on the basis of the color information for each frame. The processor 120 may then control the color temperature on the basis of the obtained at least one main color. For example, the color temperature that the processor 120 may adjust may be classified into a warm type or a cold type. Here, it may be assumed that the frame to be output (hereinafter, output frame) includes a fire scene. The processor 120 may identify (or obtain) that the main color is red on the basis of the color information included in the current output frame. The processor 120 may then identify the color temperature corresponding to the identified main color (red). Here, the color temperature corresponding to the red color may be the warm type. Meanwhile, the processor 120 may use an artificial intelligence model to obtain the color information or main color of the frame. In an embodiment, the artificial intelligence model may be stored in the electronic device 100 (e.g., memory 160). In another embodiment, the artificial intelligence model may be stored in an external server which may communicate with the electronic device 100.

Meanwhile, the electronic device 100 may be linked with an external device to control its lighting function. In detail, the electronic device 100 may receive lighting information from the external device. Here, the lighting information may include at least one of brightness information or color temperature information, set by the external device. Here, the external device may indicate a device connected to the same network as the electronic device 100 (e.g., internet of things (IOT) device included in the same home/work network) or a device that is not connected to the same network as the electronic device 100 and capable of communicating with the electronic device 100 (e.g., remote control server). For example, it may be assumed that the external lighting device (e.g., IoT device) included in the same network as the electronic device 100 outputs red light having a brightness of 50. The external lighting device (e.g., IoT device) may directly or indirectly transmit the lighting information (e.g., information indicating that red light having the brightness of 50 is output) to the electronic device 100. Here, the electronic device 100 may control the output of the light source on the basis of the lighting information received from the external lighting device. For example, if the lighting information received from the external lighting device includes information to output red light having the brightness of 50, the electronic device 100 may output red light having the brightness of 50.

Meanwhile, the electronic device 100 may control the lighting function on the basis of biometric information. In detail, the processor 120 may obtain user biometric information. Here, the biometric information may include at least one of the body temperature, heart rate, blood pressure, breath, or electrocardiogram of the user. Here, the biometric information may include various information in addition to the information described above. As an example, the electronic device 100 may include the sensor 150 for measuring the biometric information. The processor 120 may obtain the user biometric information through the sensor 150, and control the output of the light source on the basis of the obtained biometric information. As another example, the processor 120 may receive the biometric information from the external device through the communication interface 135. Here, the external device may indicate the portable communication device (e.g., smartphone or wearable device) of the user. The processor 120 may obtain the user biometric information from an external device, and control the output of the light source on the basis of the obtained biometric information. Meanwhile, in an implementation example, the electronic device may identify whether the user is sleeping, and if the user is identified as sleeping (or preparing to sleep), the processor 120 may control the output of the light source on the basis of the user biometric information.

The camera 130 may capture a surrounding environment of the electronic device 100. The camera 130 may capture the screen and the image projected onto the screen. The processor 120 may determine the number of surfaces of the screen and a shape of the image projected onto the screen on the basis of the captured image. The camera 130 may capture the facial expression, movement, gaze, or the like of the user. The processor 120 may determine predetermined information from the captured image, and perform a predetermined control operation on the basis of the determined information. For example, the camera 130 may include a charge-coupled device (CCD) sensor or a complementary metal-oxide-semiconductor (CMOS) sensor. In addition, the camera 150 may include an RGB camera or the depth camera.

The communication interface 130 may be a component for inputting and outputting at least one of an audio signal or an image signal. The communication interface 135 may receive at least one of the audio signal or the image signal from the external apparatus, and output a control command to the external apparatus.

Meanwhile, in an embodiment of the present disclosure, the communication interface 135 may be implemented as a wired communication interface of at least one of a high definition multimedia interface (HDMI), a mobile high-definition link (MHL), a universal serial bus (USB), a USB C-type, a display port (DP), a thunderbolt, a video graphics array (VGA) port, an RGB port, a D-subminiature (D-SUB), or a digital visual interface (DVI). In an embodiment, the wired communication interface may be implemented as the interface for inputting and outputting only the audio signal and the interface for inputting and outputting only the image signal, or implemented as one interface for inputting and outputting both the audio signal and the image signal.

In addition, the electronic device 100 may receive data through the wired communication interface, which is only an embodiment, and the electronic device 100 may receive power through the wired communication interface. As an example, the electronic device 100 may receive power from an external battery by using the USB C-type, or receive power from the outlet by using a power adapter. As yet another example, the electronic device 100 may receive power from the external apparatus (e.g., laptop computer or monitor) through the display port (DP).

Meanwhile, the communication interface 135 according to an embodiment of the present disclosure may be implemented as a wireless communication interface that performs the communication by using at least one of communication methods such as wireless-fidelity (Wi-Fi), Wi-Fi direct, Bluetooth, ZigBee, third generation (3G), 3rd generation partnership project (3GPP), or long term evolution (LTE). According to an implementation example, the wireless communication interface may be implemented as the interface for inputting and outputting only the audio signal and the interface for inputting and outputting only the image signal, or implemented as one interface for inputting and outputting both the audio signal and the image signal.

In addition, the audio signal may be implemented to be input through the wired communication interface, and the image signal may be implemented to be input through the wireless communication interface. The audio signal may be implemented to be input through the wireless communication interface, and the image signal may be implemented to be input through the wired communication interface.

The user interface 140 may include various types of input devices. For example, the user interface 140 could include a physical button. Here, the physical button may include a function key, a direction key (e.g., four-direction key), or a dial button. In an embodiment, the physical button may be implemented as a plurality of keys. According to another embodiment, the physical button may be implemented as one key. Here, in case that the physical button is implemented as one key, the electronic device 100 may receive the user input in which the one key is pressed for a critical time or longer. In case of receiving the user input in which the one key is pressed for the critical time or longer, the processor 120 may perform a function corresponding to the user input. For example, the processor 120 may provide the lighting function on the basis of the user input.

In addition, the user interface 140 may receive the user input by using a non-contact method. In case of receiving the user input by using a contact method, a physical force may be required to be transmitted to the electronic device. Accordingly, there may be a need for a method of controlling the electronic device regardless of the physical force. In detail, the user interface 140 may receive a user gesture and may perform an operation corresponding to the received user gesture. Here, the user interface 140 may receive the user gesture through the sensor (e.g., image sensor or infrared sensor) 150.

In addition, the user interface 140 may receive the user input by using a touch method. For example, the user interface 140 may receive the user input by using a touch sensor. In an embodiment, the touch method may be implemented as the non-contact method. For example, the touch sensor may determine whether a user body approaches within a critical distance. Here, the touch sensor may identify the user input even in case that the user does not touch the touch sensor. Meanwhile, in another implementation example, the touch sensor may identify the user input in which the user touches the touch sensor.

Meanwhile, the electronic device 100 may receive the user input in various ways other than the user interface described above. In an embodiment, the electronic device 100 may receive the user input from an external remote control device through the communication interface 135. Here, the external remote control device may be a remote control device corresponding to the electronic device 100 (e.g., control device dedicated to the electronic device) or the portable communication device (e.g., smartphone or wearable device) of the user. Here, the portable communication device of the user may store an application for controlling the electronic device. The portable communication device may obtain the user input from the application stored therein, and transmit the obtained user input to the electronic device 100. The electronic device 100 may receive the user input from the portable communication device, and perform an operation corresponding to the user's control command.

Meanwhile, the electronic device 100 may receive the user input by using voice recognition. In an embodiment, the electronic device 100 may receive a user voice through the microphone 145 included in the electronic device. In another embodiment, the electronic device 100 may receive the user voice from the microphone 145 or the external apparatus. In detail, the external apparatus may obtain the user voice through the microphone of the external apparatus, and transmit the obtained user voice to the electronic device 100. The user voice transmitted from the external apparatus may be audio data or digital data converted from the audio data (e.g., audio data converted into a frequency domain). Here, the electronic device 100 may perform an operation corresponding to the received user voice. In detail, the electronic device 100 may receive the audio data corresponding to the user voice through the microphone 145. The electronic device 100 may then convert the received audio data into the digital data. The electronic device 100 may then convert the converted digital data into text data by using a speech-to-text (STT) function. In an embodiment, the speech-to-text (STT) function may be directly performed by the electronic device 100, and in another embodiment, the speech-to-text (STT) function may be performed by the external server. The electronic device 100 may transmit the digital data to the external server. The external server may convert the digital data into the text data, and obtain control command data on the basis of the converted text data. The external server may transmit the control command data (which may here also include the text data) to the electronic device 100. The electronic device 100 may perform an operation corresponding to the user voice on the basis of the obtained control command data.

Meanwhile, the electronic device 100 may provide a voice recognition function by using one assistance (or an artificial intelligence agent such as Bixby™), which is only an embodiment, and the electronic device 100 may provide the voice recognition function by using a plurality of assistances. Here, the electronic device 100 may provide the voice recognition function by selecting one of the plurality of assistances on the basis of a trigger word corresponding to the assistance or a key included in a remote controller.

Meanwhile, the electronic device 100 may receive the user input by using a screen interaction. The screen interaction may indicate a function in which the electronic device identifies whether a predetermined event is generated through the image projected onto the screen (or projection surface), and obtains the user input on the basis of the predetermined event. Here, the predetermined event may be an event in which a predetermined object is identified at a position (e.g., position to which a user interface (UI) for receiving the user input is projected). Here, the predetermined object may include at least one of a user body part (e.g., finger), a pointer, or a laser point. The electronic device 100 may identify that the user input is received for selecting the projected UI if it is identified that the predetermined object exists at the position corresponding to the projected UI. For example, the electronic device 100 may project a guide image to display the UI on the screen. The electronic device 100 may then identify whether the user selects the projected UI. In detail, the electronic device 100 may identify that the user selects the projected UI if the predetermined event is identified at the position of the projected UI. Here, the projected UI may include at least one item. Here, the electronic device 100 may perform spatial analysis to identify whether the predetermined event exists at the position of the projected UI. Here, the electronic device 100 may perform the spatial analysis through the sensor (e.g., image sensor, infrared sensor, depth camera, or distance sensor) 150. The electronic device 100 may identify whether the predetermined event is generated at the position (for example, position to which the UI is projected) by performing the spatial analysis. In addition, if it is identified that the predetermined event is generated at the position (for example, position to which the UI is projected), the electronic device 100 may identify that the user input is received for selecting the UI corresponding to the position.

The speaker 155 may be a component for outputting the audio signal. In particular, the speaker 155 may include an audio output mixer, an audio signal processor, or an audio output module. The audio output mixer may mix the plurality of audio signals to be output as at least one audio signal. For example, the audio output mixer may mix an analog audio signal and another analog audio signal (e.g., analog audio signal received from the outside) as at least one analog audio signal. The audio output module may include the speaker or an output terminal. In an embodiment, the audio output module may include the plurality of speakers. In this case, the audio output module may be disposed in the body, and audio emitted by covering at least a portion of a diaphragm of the audio output module may pass through a waveguide to be transmitted to the outside of the body. The audio output module may include a plurality of audio output units, and the plurality of audio output units may be symmetrically arranged on the appearance of the body, and the audio may thus be emitted to all directions, for example, all directions in 360 degrees.

The memory 160 may store at least one instruction on the electronic device 100. In addition, the memory 160 may store an operating system (O/S) for driving the electronic device 100. The memory 160 may also store various software programs or applications for operating the electronic device 100 according to the various embodiments of the present disclosure. Further, the memory 160 may include a semiconductor memory such as a flash memory, or a magnetic storage medium such as a hard disk.

In detail, the memory 160 may store various software modules for operating the electronic device 100 according to the various embodiments of the present disclosure, and the processor 120 may control the operation of the electronic device 100 by executing the various software modules stored in the memory 160. The memory 160 may be accessed by the processor 120, and the processor 120 may perform readout, recording, correction, deletion, update and the like of data in the memory 160.

Meanwhile, in the present disclosure, the term “memory 160” may include the memory 160, a read only memory (ROM), or a random access memory (RAM) in the processor 120, or a memory card, for example, a micro secure digital (SD) card or a memory stick) mounted in the electronic device 100.

The power supply unit 165 may receive power from the outside and supply power to the various components of the electronic device 100. The power supply device 165 according to an embodiment of the present disclosure may receive power by using various methods. The power supply unit 165 according to an embodiment may receive power by using the connector 101 as shown in FIG. 1. In addition, the power supply unit 165 may receive power by using a direct current (DC) power cord of 220 V. However, the present disclosure is not limited thereto, and the electronic device may receive power by using a USB power cord or receive power by using a wireless charging method.

In addition, the power supply unit 165 may receive power by using an internal battery or the external battery. The power supply unit 165 according to an embodiment of the present disclosure may receive power through the internal battery. For example, the power supply unit 165 may charge power of the internal battery by using at least one of the DC power cord of 220 V, the USB power cord, or a USB C-Type power cord, and may receive power through the charged internal battery. In addition, the power supply unit 165 according to an embodiment of the present disclosure may receive power through the external battery. For example, the power supply unit 165 may receive power through the external battery in case that the electronic device and the external battery are connected to each other through various wired communication methods such as the USB power code, the USB C-type power code, or a socket groove. The power supply unit 165 may directly receive power from the external battery, or charge the internal battery through the external battery and receive power from the charged internal battery.

The power supply unit 165 according to the present disclosure may receive power by using at least one of the aforementioned plurality of power supply methods.

Meanwhile, with respect to power consumption, the electronic device 100 may have the power consumption of a predetermined value (e.g., 43 W) or less due to a socket type, another standard, etc. Here, the electronic device 100 may change the power consumption to reduce the power consumption in case of using the battery. The electronic device 100 may change the power consumption on the basis of the power supply method, power usage amount, or the like.

Meanwhile, the electronic device 100 according to an embodiment of the present disclosure may provide various smart functions.

In detail, the electronic device 100 may be connected to a portable terminal device for controlling the electronic device 100, and the screen output by the electronic device 100 may be controlled by the user input which is input from the portable terminal device. For example, the portable terminal device may be implemented as a smartphone including a touch display, the electronic device 100 may receive screen data provided by the portable terminal device from the portable terminal device and output the data, and the screen output by the electronic device 100 may be controlled on the basis of the user input which is input from the portable terminal device.

The electronic device 100 may be connected to the portable terminal device by using various communication methods such as miracast, airplay, wireless dalvik executable (DEX), and a remote personal computer (PC) method, and may share content or music, provided by the portable terminal device.

In addition, the portable terminal device and the electronic device 100 may be connected to each other by various connection methods. In an embodiment, the portable terminal device may search for the electronic device 100 and perform wireless connection therebetween, or the electronic device 100 may search for the portable terminal device and perform the wireless connection therebetween. The electronic device 100 may then output the content provided from the portable terminal device.

In an embodiment, the electronic device 100 may output the content or music being output from the portable terminal device in case that the portable terminal device is disposed around the electronic device 100 and a predetermined gesture (e.g., motion tap view) is then detected through the display of the portable terminal device, while the content or music is being output from the portable terminal device.

In an embodiment, the electronic device 100 may output the content or music being output from the portable terminal device in case that the portable terminal device becomes close to the electronic device 100 by a predetermined distance or less (e.g., non-contact tap view), or the portable terminal device touches the electronic device 100 twice at short intervals (e.g., contact tap view) while the content or music is being output from the portable terminal device.

The above embodiment describes that the screen provided by the portable terminal device is the same as the screen provided by the electronic device 100. However, the present disclosure is not limited thereto. In case that the portable terminal device and the electronic device 100 are connected to each other, the portable terminal device may output a first screen provided by the portable terminal device, and the electronic device 100 may output a second screen provided by the portable terminal device, which is different from the first screen. For example, the first screen may be a screen provided by a first application installed in the portable terminal device, and the second screen may be a screen provided by a second application installed in the portable terminal device. For example, the first screen and the second screen may be the screens different from each other that are provided by one application installed in the portable terminal device. In addition, for example, the first screen may be a screen including the UI in a remote controller form for controlling the second screen.

The electronic device 100 according to the present disclosure may output a standby screen. For example, the electronic device 100 may output the standby screen in case that the electronic device 100 and the external apparatus are not connected to each other or in case that there is no input received from the external apparatus for a predetermined time. A condition for the electronic device 100 to output the standby screen is not limited to the above-described example, and the standby screen may be output on the basis of various conditions.

The electronic device 100 may output the standby screen in the form of a blue screen, and the present disclosure is not limited thereto. For example, the electronic device 100 may obtain an atypical object by extracting only the shape of an object from the data received from the external apparatus, and output the standby screen including the obtained atypical object.

The drive unit 170 may drive at least one hardware component included in the electronic device 100. The drive unit 170 may generate the physical force and transmit the same to at least one hardware component included in the electronic device 100. Here, the drive unit 170 may generate driving power for a movement of the hardware component included in the electronic device 100 (for example, movement of the electronic device 100) or a rotation operation of the component (for example, rotation of the projection lens).

The drive unit 170 may adjust a projection direction (or the projection angle) of the projection unit 110. In addition, the drive unit 170 may move the position of the electronic device 100. Here, the drive unit 170 may control a moving member 109 to move the electronic device 100 (see FIGS. 8A and 8B). For example, the drive unit 170 may control the moving member 109 by using a motor.

FIGS. 3A to 8B are perspective views showing an appearance of the electronic device according to the various embodiments.

Referring to FIG. 3A, the electronic device 100 may include the support (or “handle”) 108a.

The support 108a in the various embodiments may be the handle or a ring, provided for the user to grip or move the electronic device 100, or the support 108a may be a stand that supports the body 105 while the body 105 is laid down in a lateral direction.

The support 108a may be connected to the body 105 by having a hinge structure to be coupled to or separated from the outer circumferential surface of the body 105, and may be selectively separated from or fixed to the outer circumferential surface of the body 105 based on a user need. The number, shape, or arrangement structure of the support 108a may be implemented in various ways without any restrictions. The support 108a may be built in the body 105, and taken out to be used by the user as needed, or the support 108a may be implemented as a separate accessory and may be detachable from the electronic device 100.

The support 108a may include a first support surface 108a-1 and a second support surface 108a-2. The first support surface 108a-1 may be one surface facing the outside of the body 105 while the support 108a is separated from the outer circumferential surface of the body 105, and the second support surface 108a-2 may be one surface facing the inside of the body 105 while the support 108a is separated from the outer circumferential surface of the body 105.

The first support surface 108a-1 may be developed from a lower portion of the body 105 to an upper portion of the body 105 while being farther away from the body 105, and the first support surface 108a-1 may have a flat or uniformly curved shape. The first support surface 108a-1 may support the body 105 if the electronic device 100 is held for the outer surface of the body 105 to be in contact with its bottom surface, For the projection lens 111 to be disposed to face the front. In an embodiment in which the electronic device 100 includes two or more supports 108a, the head 103 and the projection angle of the projection lens 111 may be adjusted by adjusting a gap between the two supports 108a or a hinge opening angle thereof.

The second support surface 108a-2 may be a surface that comes into contact with the user or an external holding structure if the support 108a is supported by the user or the external holding structure, and may have a shape corresponding to a grip structure of a user hand or the external holding structure not to slip in case of supporting or moving the electronic device 100. The user may use the electronic device 100 like a flashlight by fixing the head 103 to allow the projection lens 111 to face the front and move the electronic device 100 while holding the support 108a.

A support groove 104 may be disposed in the body 105 while having a groove structure that may accommodate the support 108a if the support 108a is not in use, and may be implemented to be disposed in the outer circumferential surface of the body 105 while having the groove structure that corresponds to a shape of the support 108a. By using the support groove 104, the support 108a may be stored in the outer circumferential surface of the body 105 if the support 108a is not in use, and the outer circumferential surface of the body 105 may be maintained to be slick.

The support 108a may be stored in the body 105 and taken out of the body 105 if the support 108a is needed. In this case, the support groove 104 may be recessed into the body 105 to accommodate the support 108a, and the second support surface 108a-2 may be in close contact with the outer circumferential surface of the body 105, or the support groove 104 may include a separate door that opens and closes the support groove 104.

The electronic device 100 may include various types of accessories that aid in the use or storage of the electronic device 100. For example, the electronic device 100 may include a protective case to easily transport the electronic device 100 while protecting the electronic device 100. The electronic device 100 may include a tripod that supports or fixes the body 105 or a bracket that is coupled to an external surface to fix the electronic device 100.

FIG. 3B shows a state where the electronic device 100 in FIG. 3A is held in contact with the bottom surface.

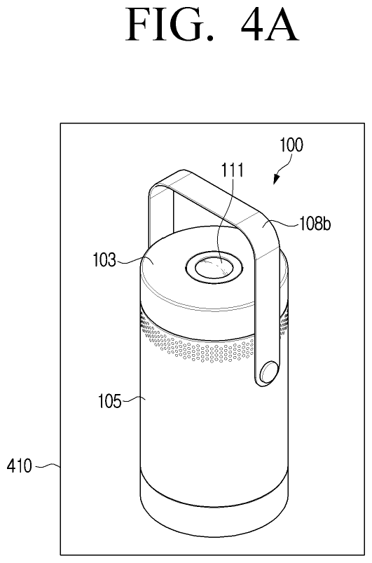

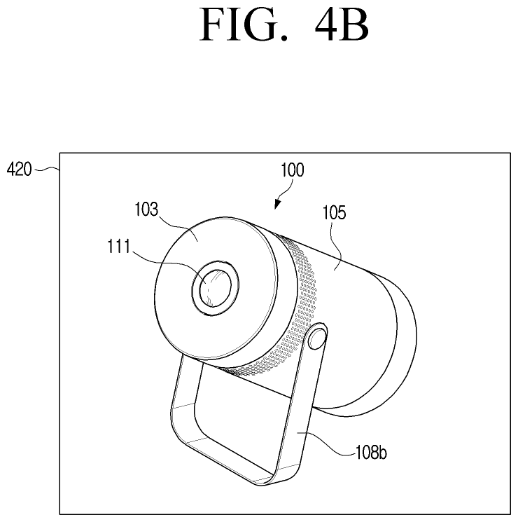

Referring to FIG. 4A, the electronic device 100 may include a support (or “handle”) 108b.

The support 108b in the various embodiments may be the handle or the ring, provided for the user to grip or move the electronic device 100. The support 108b may be a stand that supports the body 105 to be directed at an arbitrary angle while the body 105 is laid down in the lateral direction.

In detail, the support 108b may be connected to the body 105 at a predetermined point (e.g., ⅔ to ¾ of a body height) of the body 105. If the support 108b is rotated toward the body, the support 108 may support the body 105 to face an arbitrary angle while the body 105 is laid down in the lateral direction.

FIG. 4B shows a state where the electronic device 100 in FIG. 4A is held in contact with the bottom surface.

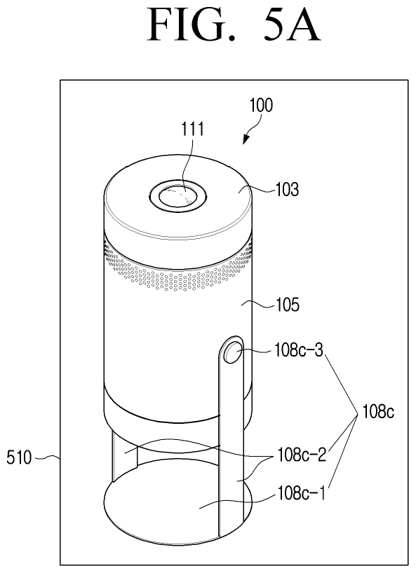

Referring to FIG. 5A, the electronic device 100 may include a support (or “pedestal”) 108c.

The support 108c in the various embodiments may include a base plate 108c-1 and two support members 108c-2, provided to support the electronic device 100 on a ground. Here, the two support members 108c-2 may each connect the base plate 108c-1 and the body 105 to each other.

In the various embodiments of the present disclosure, the two support members 108c-2 may have the same height, and each cross section of the two support members 108c-2 may thus be coupled or separated by a groove and a hinge member 108c-3, disposed on the outer circumferential surface of the body 105.

Each of the two support members may be hinge-connected to the body 105 at a predetermined point on the body 105 (e.g., ⅓ to 2/4 of the body height).

If each of the two support members and the body are coupled to each other by the hinge member 108c-3, the body 105 may be rotated around an imaginary horizontal axis formed by the two hinge members 108c-3 to thus adjust the projection angle of the projection lens 111.

FIG. 5B shows a state where the electronic device 100 in FIG. 5A is rotated.

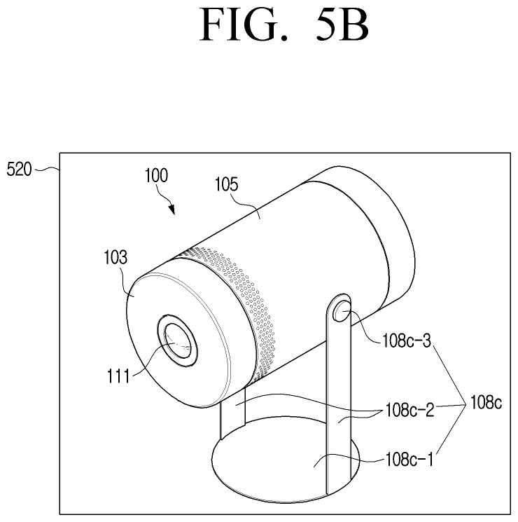

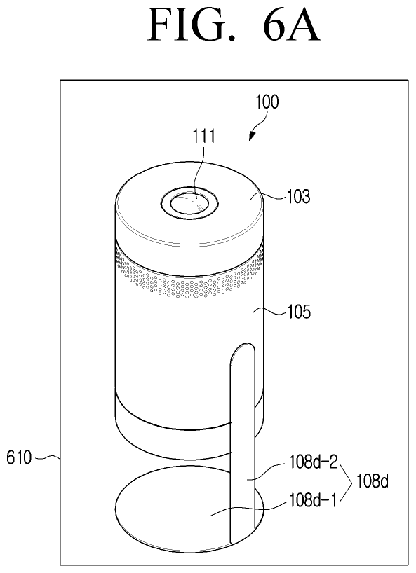

FIGS. 5A and 5B show an embodiment in which the two support members 108c-2 are connected to the body 105. However, the present disclosure is not limited thereto, and as shown in FIGS. 6A and 6B, one support member and the body 105 may be connected to each other by one hinge member.

Referring to FIG. 6A, the electronic device 100 may include a support (or “pedestal”) 108d.

The support 108d in the various embodiments may include a base plate 108d-1 provided to support the electronic device 100 on the ground and one support member 108d-2 connecting the base plate 108c-1 and the body 105 to each other.

In addition, the cross section of one support member 108d-2 may be coupled or separated by a groove and the hinge member, disposed on the outer circumferential surface of the body 105.

If one support member 108d-2 and the body 105 are coupled to each other by one hinge member, the body 105 may be rotated around an imaginary horizontal axis formed by one hinge member.

FIG. 6B shows a state where the electronic device 100 in FIG. 6A is rotated.

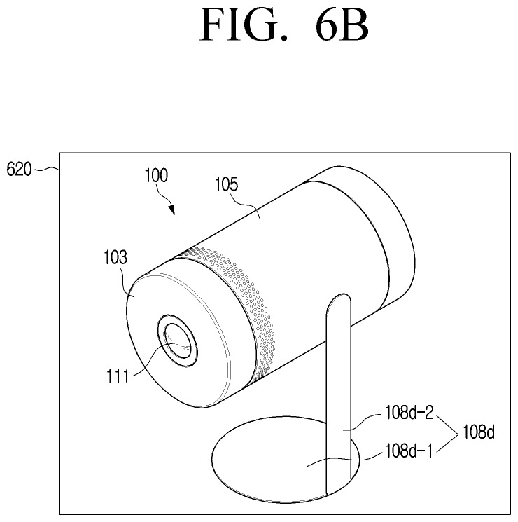

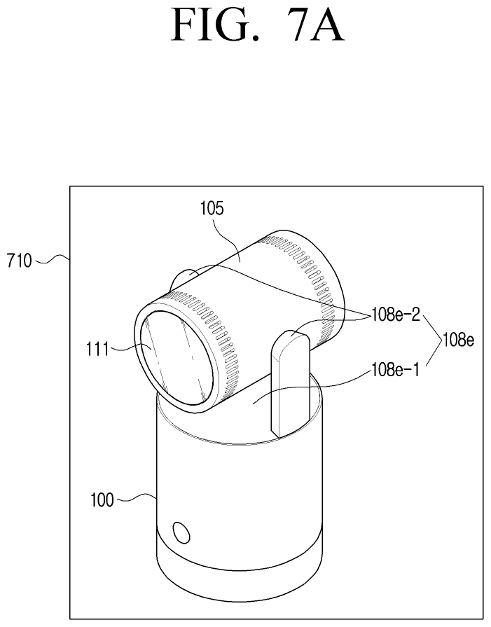

Referring to FIG. 7A, the electronic device 100 may include a support (or “pedestal”) 108e.

The support 108e in the various embodiments may include a base plate 108e-1 and two support members 108e-2, provided to support the electronic device 100 on the ground. Here, the two support members 108e-2 may connect the base plate 108e-1 and the body 105 to each other.

In the various embodiments of the present disclosure, the two support members 108e-2 may have the same height, and each cross section of the two support members 108e-2 may thus be coupled or separated by a groove and the hinge member, disposed on the outer circumferential surface of the body 105.

Each of the two support members may be hinge-connected to the body 105 at the predetermined point on the body 105 (e.g., ⅓ to 2/4 of the body height).

If the two support members and the body are coupled to each other by the hinge members, the body 105 may be rotated around an imaginary horizontal axis formed by the two hinge members to thus adjust the projection angle of the projection lens 101.

Meanwhile, the electronic device 100 may rotate the body 105 including the projection lens 101. The body 105 and the support 108e may be rotated around an imaginary vertical axis at a center point of the base plate 108e-1.

FIG. 7B shows a state where the electronic device 100 in FIG. 7A is rotated.

Meanwhile, each support shown in FIGS. 3A to 7B is only one of the various embodiments, and the electronic device 100 may have the support in any of various positions or shapes.

Referring to FIG. 8A, the electronic device 100 may include the moving member 109. The moving member 109 may indicate a member for moving the electronic device 100 from a first position to a second position in a space where the electronic device 100 is disposed. The electronic device 100 may control the moving member 109 to move the electronic device 100 by using a force generated by the drive unit 170.

FIG. 8B may be a drawing of the electronic device 100 in FIG. 8A viewed from a different direction.

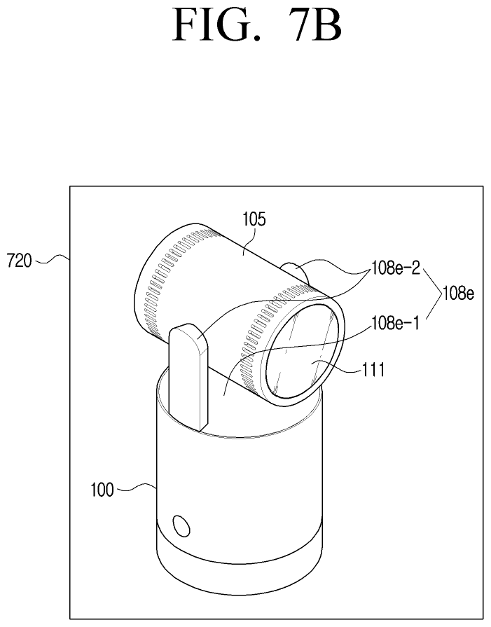

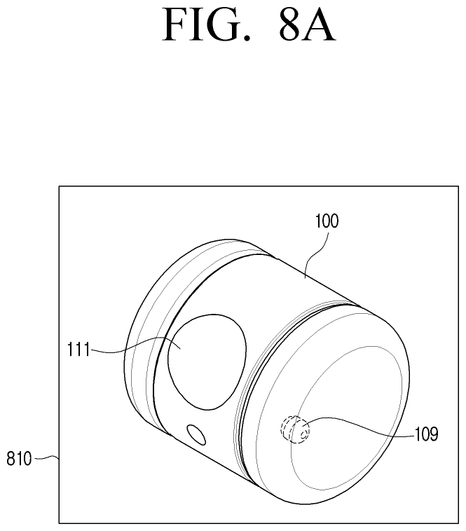

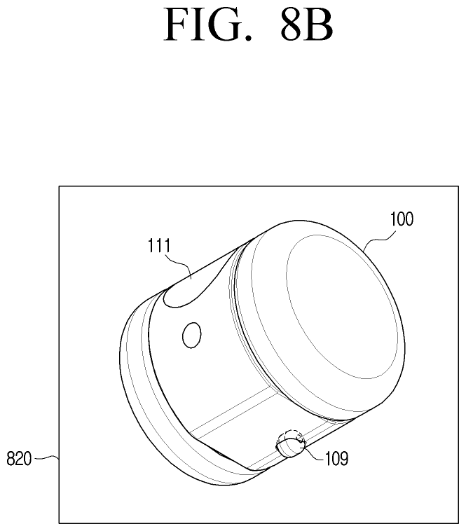

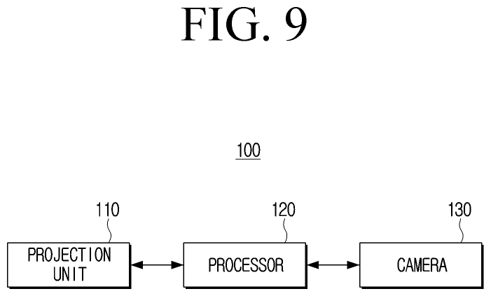

FIG. 9 is a block diagram of the electronic device according to an embodiment of the present disclosure.

Referring to FIG. 9, the electronic device 100 may include the projection unit 110, the processor 120, and the camera 130.

The projection unit 110 may project the image onto the screen. The screen may include a plurality of surfaces. In an embodiment, if the screen is a corner area of the wall surface (including a ceiling area), the screen may include two surfaces. If the screen is a vertex area of the wall surface, the screen may include three surfaces. The projection unit 110 may project the image onto the screen including the plurality of surfaces. The image projected by the projection unit 110 may be an image of content stored in the electronic device 100. The content associated with the projected image may be content input to the electronic device 100 from the external apparatus. The camera 130 may capture the screen including the plurality of surfaces and the image projected onto the screen.

The processor 120 may control each component of the electronic device 100. The processor 120 may control the projection unit 110 to project the image onto the screen, and control the camera 130 to capture the screen and the projected image.

The processor 120 may analyze the screen and the image on the basis of the image captured by the camera 130. The processor 120 may identify the number of surfaces of the screen and a shape of an area of the image projected onto each surface. The processor 120 may correct the projected image by transforming the projected image into either a three-dimensional image or a flat image on the basis of the shapes of each surface of the screen and the area of the image projected onto each surface.

In the present disclosure, the three-dimensional image may indicate an image that allows the user to feel a three-dimensional effect or an image including the three-dimensional effect. For example, if the projection surface is the corner or vertex area of the wall, the projection surface may include two or three surfaces. The electronic device 100 may identify the number of projection surfaces and classify an area of an original image into the number of projection surfaces. The electronic device 100 may transform a shape of the area of the original image classified based on a shape of the projection surface. The electronic device 100 may project the transformed image onto the projection surface. The user may feel the three-dimensional effect from the transformed image projected onto the plurality of projection surfaces. The image transformed in the present disclosure may be referred to as the three-dimensional image. The three-dimensional image may be an image that is reprocessed from the original image on the basis of the number of projection surfaces (or screens) and the shape of the projection surface. In addition, the corrected flat image in the present disclosure may indicate an image that the user perceives the entire projected image as one image. The electronic device 100 may project the original image as it is with no correction. The electronic device 100 may project the image transformed for the projected image to be viewed as a right-angled rectangle, similar to the method of transforming the image into the three-dimensional image. The flat image may indicate the original image or the image whose shape is transformed into the right-angled rectangle.

For example, the screen may include two surfaces. In addition, the area of the image projected by the electronic device 100 may be formed on each of the two surfaces. The processor 120 may correct the projected image by transforming the projected image into the three-dimensional image if the screen includes two surfaces and a smaller area of the image between the respective areas of the image projected onto the two surfaces has a horizontal top or bottom edge.

The screen may include three surfaces. In addition, the area of the image projected by the electronic device 100 may be formed on each of the three surfaces. The processor 120 may correct the projected image by transforming the projected image into the three-dimensional image if the screen includes three surfaces and every area of the image projected onto each surface of the screen includes four or more edges. The processor 120 may correct the projected image by transforming the projected image into the flat image if the screen includes three surfaces and at least one area of the image projected onto each surface of the screen includes three edges.

In addition, the processor 120 may determine a movement of the electronic device occurs, and identify each surface of the screen and the shape of the area of the image projected onto each surface if the movement of the electronic device is not detected. For example, the processor 120 may determine whether the movement of the electronic device occurs on the basis of whether a movement of the projected image, included in the captured image, occurs. The processor 120 may compare a previously captured image frame with a current or subsequent captured image frame. The processor 120 may determine whether the movement of the electronic device 100 occurs on the basis of a movement of an object included in each image frame or a difference in position of the same object in each frame. The electronic device 100 may further include the sensor. The processor 120 may determine whether the movement of the electronic device 100 occurs on the basis of data detected by the sensor. For example, the sensor may include an acceleration sensor, a gravity sensor, a gyro sensor, a geomagnetic sensor, a direction sensor, or the like.

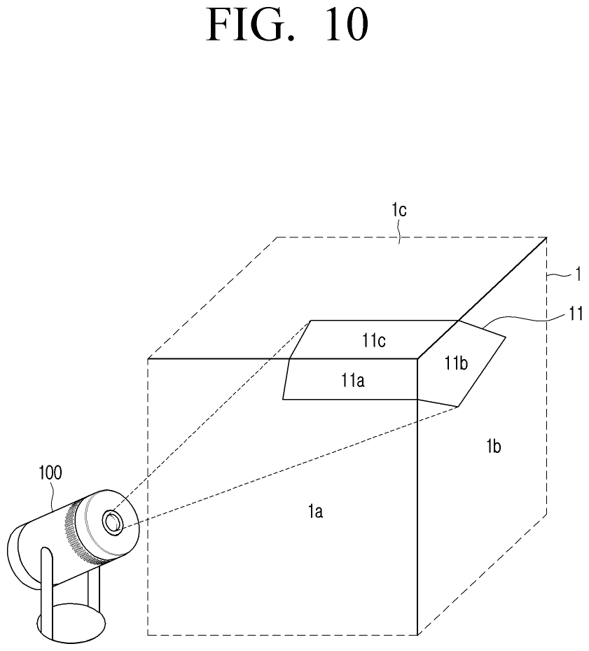

FIG. 10 is a view for explaining the electronic device for projecting the image onto the screen including the plurality of surfaces according to an embodiment of the present disclosure.

Referring to FIG. 10, the electronic device 100 may project the image onto the screen. In an embodiment, a screen 1 may be the wall surface (including the ceiling), and the screen 1 on which the image is formed may include a left wall surface la, a right wall surface 1b, and a ceiling 1c. If the image is projected onto the vertex area of the wall surface, the projected image by the electronic device 100 may include each of a left image 11a, a right image 11b, and an upper image 11c. The left image 11a may be an image projected onto the left wall surface la, the right image 11b may be an image projected onto the right wall surface 1b, and the upper image 11c may be an image projected onto the ceiling 1c. FIG. 8 shows an example in which the electronic device 100 projects the image onto the vertex area of the wall surface. However, the electronic device 100 may also project the image onto the corner area of the wall surface. In this case, the screen 1 on which the image is formed may include the left wall surface la and the right wall surface 1b. In addition, the image projected by the electronic device 100 may include the left image 11a and the right image 11b. The left image 11a may be the image projected onto the left wall surface 1a, and the right image 11b may be the image projected onto the right wall surface.

The electronic device 100 may capture the screen 1 and the images 11a, 11b, and 11c projected onto the respective areas of the screen. The electronic device 100 may analyze each area of the screen and the image projected onto each area based on the captured image. The electronic device 100 may correct the projected image by transforming the projected image into the three-dimensional image or the flat image on the basis of an analysis result.

The description describes below a detailed process for the electronic device 100 to transform the image into the three-dimensional image or the flat image.

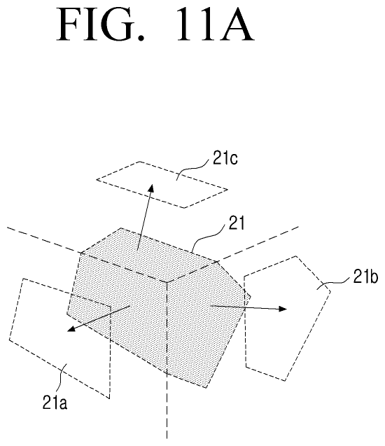

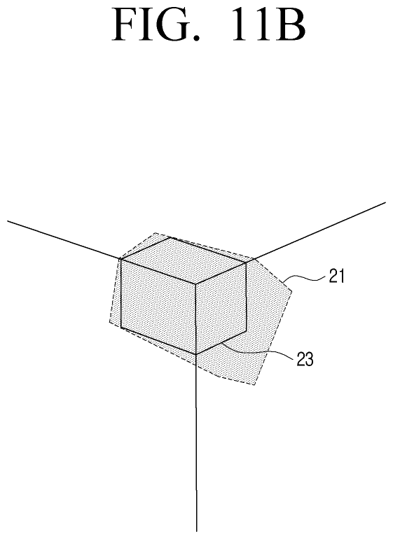

FIGS. 11A and 11B are views for explaining a process of providing the three-dimensional image if the image is projected onto a screen including three surfaces according to an embodiment of the present disclosure. This process is described with reference to FIGS. 11A and 11B.

Referring to FIG. 11A, a left image 21a, a right image 21b, and an upper image 21c may respectively be formed on the three surfaces of the screen. The left image 21a may have a quadrilateral shape that includes an obtuse or acute angle. The right image 21b may have a pentagonal shape. The upper image 21c may have a parallelogram shape. The shape of each image described above is an embodiment, and each image may have various shapes based on a location of the image being projected.

The electronic device 100 may capture the screen and a projected image 21. The electronic device 100 may identify the number of surfaces of the screen and the shape of the projected image on the basis of the captured image. For example, as shown in FIG. 11A, the electronic device 100 may identify the three surfaces 1a, 1b, and 1c of the screen, and may identify the shape of each surface of the screen. The electronic device 100 may classify the projected image into a plurality of areas of the image based on each surface of the screen. If the screen has three surfaces, the electronic device 100 may classify (or segment) the projected image into three areas of the image corresponding to the respective surfaces of the screen. In addition, the electronic device 100 may identify each shape of the three areas of the image. For example, the electronic device 100 may identify that the left image 21a formed on the left wall surface la has the quadrilateral shape that includes the obtuse or acute angle, the right image 21b formed on the right wall surface 1b has the pentagonal shape, and the upper image 21c formed on the ceiling 1c has the parallelogram shape.

The electronic device 100 may individually transform each classified area of the image to correspond to the surface of the screen. For example, the electronic device 100 may transform each of the left image 21a and the right image 21b into the parallelogram shape corresponding to the surface of the screen. The electronic device 100 may not transform the upper image 21c if the upper image 21c is identified as having a shape corresponding to the shape of the ceiling 1c. The electronic device 100 may also transform the shape of the upper image 21c to correspond to the shape of the ceiling 1c if the upper image 21c is identified as having a shape that does not correspond to the shape of the ceiling 1c. The electronic device 100 may merge the respective areas of the image that are transformed to correspond to the respective surfaces of the screen. In addition, the electronic device 100 may project the merged image.

FIG. 11B shows an initially projected image 21 and a transformed and projected three-dimensional image 23.

The electronic device 100 may adjust a position of each area of the image for image consistency in case of merging the respective areas of each image. For example, the electronic device 100 may adjust the position of each area of the image for the line or surface of an object to be continuous (or coincident) if the object that includes the line or surface in the image spans two or more areas of the image. In this way, the transformed three-dimensional image 23 may allow the user to feel the three-dimensional effect without any sense of incongruity.

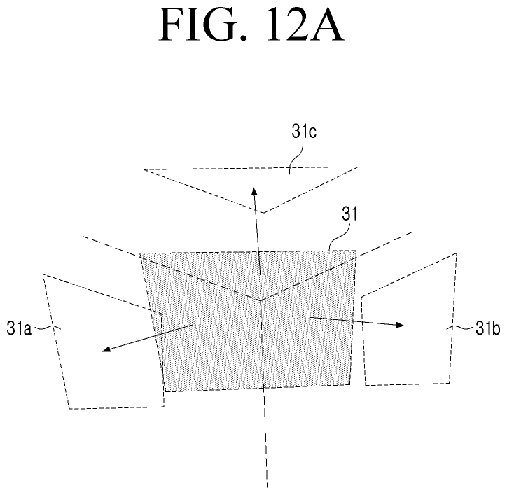

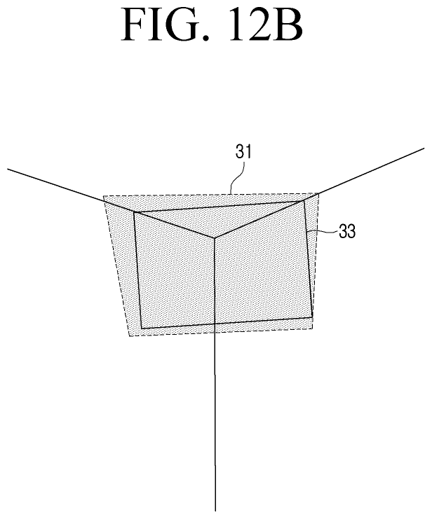

FIGS. 12A and 12B are views for explaining a process of providing the flat image if the image is projected onto the screen including three surfaces according to an embodiment of the present disclosure. This process is described with reference to FIGS. 12A and 12B.

FIG. 12A shows the image having a shape different from FIG. 11A and projected onto each of the three surfaces of the screen. For example, each of a left image 31a and a right image 31b may have the quadrilateral shape that includes the obtuse or acute angle. An upper image 31c may have a triangular shape.

The electronic device 100 may capture the screen and a projected image 31, and identify the number of surfaces of the screen and the shape of the projected image. For example, as shown in FIG. 11A, the electronic device 100 may identify the three surfaces 1a, 1b, and 1c of the screen, and may identify the shape of each surface of the screen. The electronic device 100 may classify the projected image into the plurality of areas of the image based on the respective surfaces of the screen. If the screen has three surfaces, the electronic device 100 may classify (or segment) the projected image into three areas of the image corresponding to the respective surfaces of the screen. In addition, the electronic device 100 may identify each shape of the three areas of the image. For example, the electronic device 100 may identify each of the left image 31a and the right image 31b as having the quadrilateral shape that includes the obtuse or acute angle, and identify the upper image 31c as having the triangular shape.

The electronic device 100 may correct the projected image 31 by transforming the projected image 31 into the flat image if at least one area of the image projected onto each surface of the screen includes three edges. The electronic device 100 may individually transform each classified area of the image. For example, the electronic device 100 may transform each of the left image 31a and the right image 31b into an image having a parallel bottom edge. The electronic device 100 may not transform the upper image 31c if the top edge of the upper image 31c is parallel to each bottom edge of the transformed left and right images 31a and 31b. The electronic device 100 may transform the shape of the upper image 31c for the top edge of the upper image 31c to be parallel to each of the left image 31a and the right image 31b if the bottom edge of the upper image 31c is not parallel to each bottom edge of the left image 31a and the right image 31b. The electronic device 100 may merge the respective transformed areas of the image. In addition, the electronic device 100 may project the merged image. Here, “parallel” may indicate being parallel to the bottom surface.

FIG. 12B shows an initially projected image 31 and a transformed and projected flat image 33.

The electronic device 100 may adjust the position of each area of the image for the image consistency in case of merging the respective areas of each image. For example, the electronic device 100 may adjust the position of each area of the image for the line or surface of the object to be continuous (or coincident) if the object that includes the line or surface in the image spans two or more areas of the image. Therefore, the user may view the flat image 33 without any sense of incongruity.

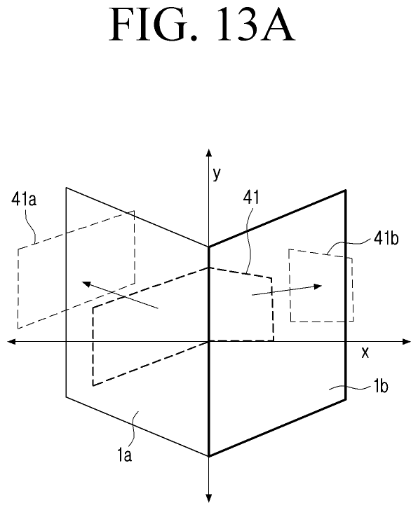

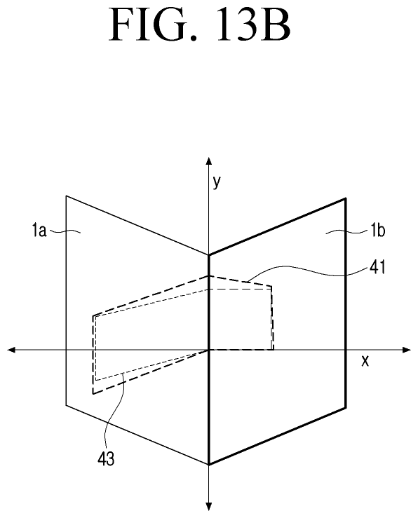

FIGS. 13A and 13B are views for explaining a process of providing the three-dimensional image if the image is projected onto the screen including two surfaces according to an embodiment of the present disclosure. This process is described with reference to FIGS. 13A and 13B.

Referring to FIG. 13A, the electronic device 100 may project an image 41 onto the corner area of the wall surface. The screen 1 may include the left wall surface la and the right wall surface 1b. In addition, the projected image 41 may include each of a left image 41a and a right image 41b. The left image 41a may be an image projected onto the left wall surface 1a, and the right image 41b may be an image projected onto the right wall surface 1b. The left image 41a may have the parallelogram shape. The right image 41b may have the quadrilateral shape that includes the obtuse or acute angle.

The electronic device 100 may capture the screen and the projected image 41. The electronic device 100 may identify the number of surfaces of the screen and the shape of the projected image on the basis of the captured image. For example, as shown in FIG. 13A, the electronic device 100 may identify the two surfaces 1a and 1b of the screen, and may identify the shape of each surface of the screen. The electronic device 100 may classify the projected image into the plurality of areas of the image based on the respective surfaces of the screen. If the screen has two surfaces, the electronic device 100 may classify (or segment) the projected image into two areas of the image corresponding to the respective surfaces of the screen. In addition, the electronic device 100 may identify each shape of the two areas of the image. For example, the electronic device 100 may identify that the left image 41a has the parallelogram shape, and the right image 41b has the quadrilateral shape that includes the obtuse or acute angle. The electronic device 100 may correct the projected image 41 by transforming the projected image 41 into the three-dimensional image if the of a smaller area of the image between the image areas respectively projected onto the two surfaces has the horizontal top or bottom edge. Referring to FIG. 13A, a size of the right image 41b may be smaller than a size of the left image. In addition, the right image 41b may have the horizontal bottom edge.

The electronic device 100 may individually transform each classified area of the image to correspond to the surface of the screen. For example, the electronic device 100 may transform the left image 21a into the parallelogram shape and the right image 21b into the right-angled rectangular shape. The electronic device 100 may merge the respective transformed areas of the image. In addition, the electronic device 100 may project the merged image.

FIG. 13B shows the initially projected image 41 and a transformed and projected three-dimensional image 43.

The electronic device 100 may adjust the position of each area of the image for the image consistency in case of merging the respective areas of each image. For example, the electronic device 100 may adjust the position of each area of the image for the line or surface of the object to be continuous (or coincident) if the object that includes the line or surface in the image spans two or more areas of the image. In this way, the transformed three-dimensional image 43 may allow the user to feel the three-dimensional effect without any sense of incongruity

Hereinabove, the description describes the various embodiments of correcting the projected image by transforming the projected image into the three-dimensional image or the flat image. The following description describes a control method of an electronic device.

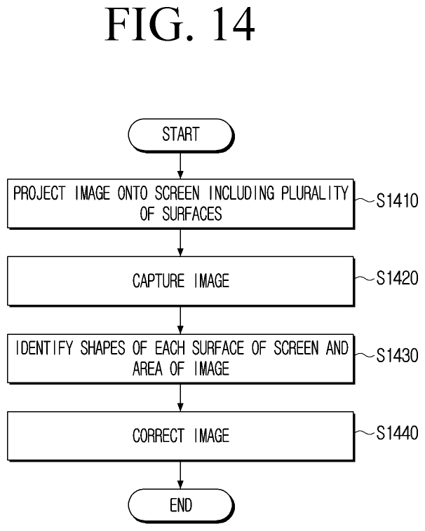

FIG. 14 is a flowchart for explaining the control method of an electronic device according to an embodiment of the present disclosure.

Referring to FIG. 14, an electronic device 100 may project an image onto a screen including a plurality of surfaces (S1410). For example, the screen may be a wall surface (including a ceiling). If the screen onto which the electronic device 100 projects the image is a vertex area of the wall surface, the screen may include three surfaces of a left wall surface, a right wall surface, and the ceiling. If the screen onto which the electronic device 100 projects the image is a corner area of the wall surface, the screen may include two surfaces of the left wall surface and the right wall surface.

The electronic device 100 may capture an image including the screen including the plurality of surfaces and the projected image (S1420). The electronic device 100 may then identify shapes of each surface of the screen and an area of the image on the basis of the captured image (S1430). The electronic device 100 may identify the left area (e.g., left wall surface), right area (e.g., right wall surface), or upper area (e.g., ceiling) of the screen from the captured image. In addition, the electronic device 100 may identify the area of the image projected onto each area of the screen. For example, the electronic device 100 may identify a left image, a right image, or an upper image, projected onto each area of the screen. The electronic device 100 may identify a shape of each identified image.

In addition, the electronic device 100 may determine whether the movement of the electronic device 100 occurs. The electronic device 100 may identify the shapes of each surface of the screen and the area of the image projected onto each surface on the basis of the captured image if the movement of the electronic device 100 is not detected.

For example, the electronic device 100 may determine whether the movement of the electronic device occurs on the basis of whether the movement of the projected image, included in the captured image, occurs. The electronic device 100 may include a sensor, and determine whether the movement of the electronic device 100 occurs on the basis of the information detected by the sensor.

The electronic device 100 may correct the projected image (S1440). The electronic device 100 may correct the projected image by transforming the projected image into either a three-dimensional image or a flat image on the basis of the shapes of each surface of the screen and the area of the image projected onto each surface.

For example, the electronic device 100 may correct the projected image by transforming the projected image into the three-dimensional image if the screen includes two surfaces and a smaller area of the image between the image areas projected onto each of the two surfaces has a horizontal top or bottom edge. The electronic device 100 may correct the projected image by transforming the projected image into the three-dimensional image if the screen includes three surfaces and every area of the image projected onto each surface of the screen includes four or more edges. The electronic device 100 may correct the projected image by transforming the projected image into the flat image if the screen includes three surfaces and at least one area of the image projected onto each surface of the screen includes three edges.

The electronic device may project the corrected three-dimensional image or flat image onto the screen. The user may feel a three-dimensional effect from the three-dimensional image projected onto the screen including the plurality of surfaces, and may enjoy a natural image from the flat image regardless of the shape of the screen.

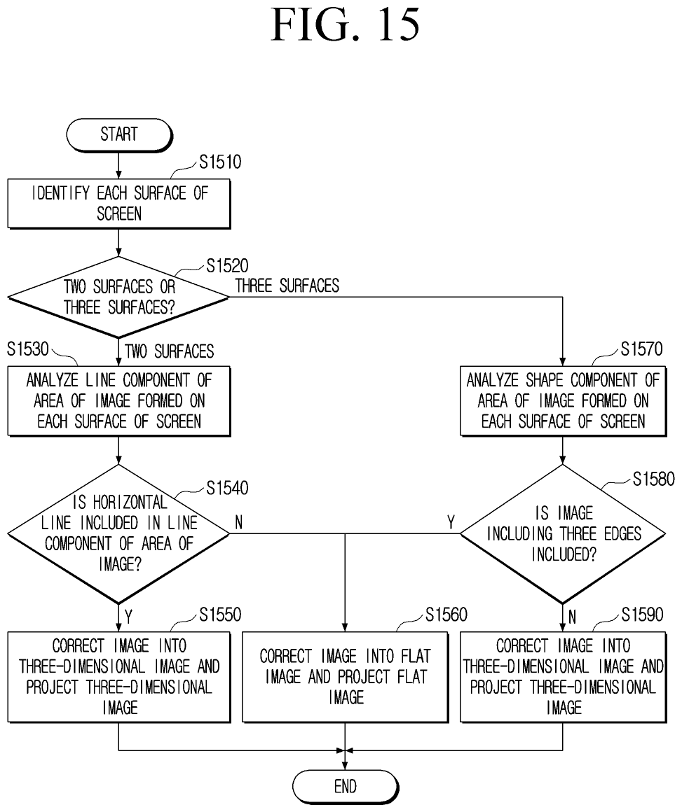

FIG. 15 is a flowchart for explaining a method of selectively implementing the flat image or the three-dimensional image if the image is projected onto the screen including the plurality of surfaces according to an embodiment of the present disclosure.

Referring to FIG. 15, the electronic device 100 may capture the screen and the image projected onto the screen. In addition, the electronic device 100 may identify each surface of the screen on the basis of the captured image (S1510). The electronic device 100 may determine whether the screen has two surfaces or three surfaces (S1520). If the screen onto which the electronic device 100 projects the image is the corner area of the wall surface, the screen may have two surfaces. If the screen onto which the electronic device 100 projects the image is the vertex area of the wall surface, the screen may have three surfaces.

The electronic device 100 may analyze a line component of the area of the image formed on each surface of the screen if the surface of the screen is determined as having two surfaces (S1530). For example, the electronic device 100 may analyze each of the left image and the right image. The electronic device 100 may determine whether a horizontal line is included in the line component of the left or right image (S1540). In an embodiment, the electronic device 100 may determine whether the top or bottom edge of a smaller area of the image between the two areas of the image has the horizontal line.

The electronic device 100 may correct the projected image by transforming the projected image into the three-dimensional image and project the same if the analyzed line component of the area of the image includes the horizontal line (S1550). The electronic device 100 may correct the projected image by transforming the projected image into the flat image and project the same if the analyzed line component of the area of the image includes no horizontal line (S1560). The electronic device 100 may project the image with no correction if the analyzed line component of the area of the image includes no horizontal line.

The electronic device 100 may analyze the shape of the area of the image formed on each surface of the screen if the surface of the screen is determined as having three surfaces (S1570). For example, the electronic device 100 may analyze each of the left image, the right image, and the upper image. The electronic device 100 may determine whether an image including three edges is included in the three areas of the image. The electronic device 100 may determine whether a triangular-shaped image is included in the three areas of the image (S1580).

The electronic device 100 may transform the projected image into the flat image if the triangular-shaped image is included in the areas (S1560). The electronic device 100 may transform the projected image into the three-dimensional image if the triangular-shaped image is not included in the areas (S1590).

The electronic device 100 may determine whether the movement of the electronic device 100 occurs. The electronic device 100 may not perform the image analysis process if it is determined that the movement occurs. The electronic device 100 may perform the image analysis process on the basis of images of the screen and the projected image, captured at a determination point in time if it is determined that no movement occurs. For example, the electronic device 100 may determine whether the movement occurs by comparing a currently captured image with a previously captured image. The electronic device 100 may include the sensor, and determine whether the movement of the electronic device 100 occurs on the basis of the information detected by the sensor.

The control method of an electronic device according to the various embodiments described above may be provided as a computer program product. The computer program product may include a software (S/W) program itself or a non-transitory computer readable medium in which the S/W program is stored.

The non-transitory computer readable medium is not a medium that stores data therein for a while, such as a register, a cache, or a memory, and indicates a medium that semi-permanently stores data therein and is readable by a machine. In detail, the various applications or programs described above may be stored and provided in the non-transitory computer readable medium such as a compact disk (CD), a digital versatile disk (DVD), a hard disk, a Blu-ray disk, a universal serial bus (USB), a memory card, or a read only memory (ROM).

In addition, although the embodiments are shown and described in the present disclosure as above, the present disclosure is not limited to the above-mentioned embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic device comprising:
a projector;
a camera;
one or more processors; and
memory storing instructions that, when executed by the one or more processors, cause the electronic device to:
control the projector to display a projected image on a screen, wherein the screen comprises a plurality of surfaces;
control the camera to obtain a captured image comprising the plurality of surfaces and the projected image;
identify, based on the captured image, shapes of the plurality of surfaces and a plurality of areas of the projected image projected onto the plurality of surfaces; and
correct the projected image, based on the shapes of the plurality of surfaces and the plurality of areas of the projected image, by transforming the projected image into one from among a three-dimensional image and a flat image.

2. The electronic device as claimed in claim 1, wherein the one or more processors are configured to execute the instructions to cause the electronic device to correct the projected image by transforming the projected image into the three-dimensional image based on:
the plurality of surfaces comprising a first surface and a second surface, and
a smallest area, from among a first area projected onto the first surface and a second area projected onto the second surface, having a horizontal top edge or a horizontal bottom edge.

3. The electronic device as claimed in claim 2, wherein the one or more processors are configured to execute the instructions to cause the electronic device to:
segment the projected image into the first area and the second area;
correct the first area by transforming the first area into a right-angled rectangular shape;
correct the second area by transforming the second area into a parallelogram;
obtain a merged image by merging the first area and the second area; and
project the merged image.

4. The electronic device as claimed in claim 1, wherein the one or more processors are configured to execute the instructions to cause the electronic device to correct the projected image by transforming the projected image into the three-dimensional image based on:
the plurality of surfaces comprising three surfaces, and
the plurality of areas of the projected image each having four or more edges.

5. The electronic device as claimed in claim 4, wherein the one or more processors are configured to execute the instructions to cause the electronic device to:
segment the projected image into three areas;
correct the three areas, based on three corresponding surface shapes, by transforming the three areas into parallelograms;
obtain a merged image by merging the three areas; and
project the merged image.

6. The electronic device as claimed in claim 1, wherein the one or more processors are configured to execute the instructions to cause the electronic device to correct the projected image by transforming the projected image into the flat image based on:
the plurality of surfaces comprising three surfaces, and
at least one of the plurality of areas of the projected image comprising three edges.

7. The electronic device as claimed in claim 6, wherein the one or more processors are configured to execute the instructions to cause the electronic device to:
segment the projected image into three areas;
correct two side areas, from among the three areas, to have parallel bottom edges;
obtain a merged image by merging the three areas; and
project the merged image.

8. The electronic device as claimed in claim 1, wherein the one or more processors are configured to execute the instructions to cause the electronic device to:
determine whether movement of the electronic device has occurred; and
identify, based on determining no movement has occurred:
the shapes of the plurality of surfaces, and
the plurality of areas of the projected image.

9. The electronic device as claimed in claim 8, wherein the one or more processors are configured to execute the instructions to cause the electronic device to determine whether movement of the electronic device has occurred by detecting movement of the projected image in the captured image.

10. The electronic device as claimed in claim 8, further comprising a sensor,
wherein the one or more processors are configured to execute the instructions to cause the electronic device to:
control the sensor to obtain detected information about movement of the electronic device; and
determine whether movement of the electronic device has occurred based on the detected information.

11. A control method of an electronic device, comprising:
displaying a projected image on a screen including a plurality of surfaces;
obtaining a captured image comprising the plurality of surfaces and the projected image;
identifying, based on the captured image, shapes of the plurality of surfaces and a plurality of areas of the projected image; and
correcting the projected image, based on the shapes of the plurality of surfaces and the plurality of areas of the projected image, by transforming the projected image into one from among a three-dimensional image and a flat image.

12. The control method as claimed in claim 11, wherein the correcting the projected image comprises transforming the projected image into the three-dimensional image based on:
the plurality of surfaces including a first surface and a second surface, and
a smallest area, from among a first area projected onto the first surface and a second area projected onto the second surface, having a horizontal top edge or a horizontal bottom edge.

13. The control method as claimed in claim 12, wherein the correcting the projected image comprises:
segmenting the projected image into the first area and the second area;
correcting the first area by transforming the first area into a right-angled rectangular shape;
correcting the second area by transforming the second area into a parallelogram;
obtaining a merged image by merging the first area and the second area; and
projecting the merged image.

14. The control method as claimed in claim 11, wherein the correcting the projected image comprises transforming the projected image into the three-dimensional image based on:
the plurality of surfaces including three surfaces, and
the plurality of areas of the projected image each having four or more edges.

15. The control method as claimed in claim 14, wherein the correcting the projected image comprises:
segmenting the projected image into three areas;
correcting the three areas, based on three corresponding surface shapes, by transforming the three areas into parallelograms;
obtaining a merged image by merging the three areas; and
projecting the merged image.

16. The control method as claimed in claim 11, wherein the correcting the projected image comprises transforming the projected image into the flat image based on:
the plurality of surfaces comprising three surfaces, and
at least one of the plurality of areas of the projected image comprising three edges.

17. The control method as claimed in claim 16, wherein the correcting the projected image comprises:
segmenting the projected image into three areas;
correcting two side areas, from among the three areas, to have parallel bottom edges;
obtaining a merged image by merging the three areas; and
projecting the merged image.

18. The control method as claimed in claim 11, wherein the identifying the shapes of the plurality of surfaces and the plurality of areas of the projected image comprises:
determining whether movement of the electronic device has occurred; and
identifying, based on determining no movement has occurred:
the shapes of the plurality of surfaces, and
the plurality of areas of the projected image.

19. The control method as claimed in claim 18, wherein the determining whether the movement has occurred is based on detecting movement of the projected image in the captured image.

20. A non-transitory computer-readable recording medium having instructions recorded thereon, that, when executed by one or more processors, cause the one or more processors to:
control a projector to display a projected image on a screen, wherein the screen comprises a plurality of surfaces;
control a camera to obtain a captured image comprising the plurality of surfaces and the projected image;
identify, based on the captured image, shapes of the plurality of surfaces and a plurality of areas of the projected image projected onto the plurality of surfaces; and
correct the projected image, based on the shapes of the plurality of surfaces and the plurality of areas of the projected image, by transforming the projected image into one from among a three-dimensional image and a flat image.
